(19) United States
(12) Patent Application Publication
(10) Pub. No.: US 2009/0113899 A1
(43) Pub. Date: May 7, 2009

(54) Systems and Methods for Ultra Low Temperature Storage

(76) Inventors: John Dain, Hollister, CA (US); Boyd Bowdish, Los Gatos, CA (US); Nick Hanneman, Tres Pinos, CA (US)

Correspondence Address: TRAN & ASSOCIATES, 6768 MEADOW VISTA CT., SAN JOSE, CA, 95135, US

(21) Appl. No.: 11/934,693

(22) Filed: Nov. 2, 2007

(51) Int. Cl. F17C 9/00; F25D 11/04; F25B 39/02; F25D 19/00

(52) U.S. Cl. 62/48.1; 62/440; 62/524; 62/449

(57) ABSTRACT

Systems and methods are disclosed to provide an ultra low temperature (ULT) cryogenic processor apparatus. The apparatus includes an external housing with flat sides; an inner housing coupled to the external housing to define a vacuum region there between; material disposed in the vacuum region to provide redundant insulation and structural support; and a cryogenic heat exchanger contained in the inner housing.

### FIELD OF THE INVENTION

The present invention relates to storage of samples at ULT (ultra low temperature), typically lower than −90 degrees C.

### BACKGROUND OF THE INVENTION

There is an increasing need for sample storage at temperatures ranging from room temperature (20 degrees C.) down to ULT as low as −150 degrees C. In certain applications such as storing sensitive tissues and vaccines, the storage systems need to be able to reach the required low temperature, but to continuously maintain that temperature accurately and reliably since even temporary loss of cooling could weaken, damage or even destroy existing supplies of vaccines, for example. As many of such stored substances are precious not replaceable because they were derived from control studies of such vaccines, e.g. very costly and having been accumulated over a long period of time, thus requiring an extremely long time for replacement, so loss in storage could place large populations at risk.

Many refrigeration and cryopreservation systems of known art have limitations in temperature range and uniformity, capacity and reliability that would preclude their utilization in this demanding field of endeavor. Depending on their configuration, the open-door time required for loading or unloading samples could allow an unacceptable rise in temperature. Conventional ULT systems without redundant evaporators and/or highly efficient thermal insulation have a very short survival time, typically only a few hours, before loss of set point temperature, in the event of failure due to leakage of refrigerant, line blockage, motor or pump failure, electrical power outage or many other potential causes.

### SUMMARY

Systems and methods are disclosed to provide an ultra low temperature (ULT) cryogenic processor apparatus. The apparatus includes an external housing with flat sides; an inner housing coupled to the external housing to define a vacuum region there between; material disposed in the vacuum region to provide redundant insulation and structural support; and a cryogenic heat exchanger contained in the inner housing.

Implementations of the above aspect may include one or more of the following. The material can be an insulation material with one of: a silica micro balloon, polyisocyanurate. The vacuum region can be processed by removing residual water vapor and other partial pressure of contaminants. The vacuum region is evacuated to a partial pressure of approximately 0.2 milliTorr. The cryogenic heat exchanger can include one or more tubings and may include redundant tubings. The cryogenic heat exchanger can be U-shaped tubings covering at least three walls of the payload bay. The cryogenic heat exchanger can include tubings covering at least four sides of the payload bay. Alternatively, the cryogenic heat exchanger can be one or more coils positioned on the top and/or the bottom of the vessel. A port can connect to the one or more tubings to provide input and output connections thereto. A door can allow access to the payload bay, wherein the door comprises three or more materials having different thermal characteristics.

In another aspect, a method to provide ultra low temperature processing and/or storage includes providing insulation and structural support using a material disposed in a vacuum region between an external housing and an inner housing; and cryogenically processing one or more compartments contained in the payload bay.

Implementations of the above aspect may include one or more of the following. The material can be an insulation material with silica micro balloon technology. The process can remove water vapor, partial pressure contaminates and atmospheric gases from the vacuum region. The process includes evacuating the vacuum region to approximately 0.2 millitorr. The cryogenic heat exchanger can have one or more heat exchange tubings, and can include redundant tubings. The redundant tubings can be a complete set of heat exchange tubings operating in parallel with the primary heat exchange tubings. The redundant tubings can have one or more tubings branched from the primary heat exchange tubings. The cryogenic heat exchanger can also include U-shaped tubings covering at least three walls of the inner housing. The tubings can cover at least four sides of the inner housing. A door can be formed with a plurality of materials each having different thermal characteristics. A changeable rack assembly is supported in the chamber. The system can transmit energy from the payload bay into the heat exchanger through the changeable rack assembly. A negative pressure in the payload bay can be maintained through the use of pneumatic seals on the main door assembly. The cryogenics vacuum pumping via the heat exchanger can provide energy removal from the payload bay and into the heat exchanger. The surfaces of at least one of the external and inner housing can be flat surfaces.

Advantages of the preferred embodiment may include one or more of the following. The preferred embodiment provides a ULT chamber which is made in compact rectangular form, as opposed to circular or cylindrical form. The preferred embodiment also provides a substantially flat vertical door serving as the front panel of the chamber. The preferred embodiments of the ULT refrigeration system provide long term processing of biological material at ultra-low temperature, e.g. down to −90 deg.C, with an ultimate target of −150 deg.C. The embodiment provides temperature accuracy independent of ambient conditions of temperature and humidity while maintaining uniformity of temperature throughout the chamber. The embodiment has an optimal chamber size and shape and requires minimal floor space. Low operating costs are achieved through the cryogenic refrigeration method and insulation efficiency. In various embodiments, the insulation provides additional reliability in event of failure of internal tube or external refrigeration source. Components of the system can be easily accessed for maintenance purposes with minimal side effects. The design allows for ease of manufacturability and assembly. The preferred embodiments of the system can be flexibly manufactured to different sizes and requirements at a low cost.

### BRIEF DESCRIPTION OF THE DRAWINGS

FIG. 1 shows one embodiment of a cryogenic processor housing with one or more shells.

FIG. 2 shows the housing of FIG. 1 with an inner tub.

FIG. 3 shows a configuration of refrigerant tubings positioned in the inner tub of FIG. 2.

FIG. 4 shows a storage chamber that is cooled by the refrigerant tubings of FIG. 3.

FIG. 5A shows a left view of an exemplary door assembly, while FIG. 5B shows a front view of the door assembly.

FIG. 6A shows an exemplary top cooling coil configuration.

FIG. 6B shows an exemplary side cooling coil configuration.

FIG. 7A shows an exemplary adaptable and interchangeable rack mount system in the payload bay.

FIG. 7B shows a five rack embodiment, while FIG. 7C shows a fifteen rack embodiment.

FIG. 7D shows a back view and an inner side view of the five rack embodiment of FIGS. 8A-8B.

FIG. 7E shows an exploded view of yet another embodiment of a cryogenic processor.

### DESCRIPTION

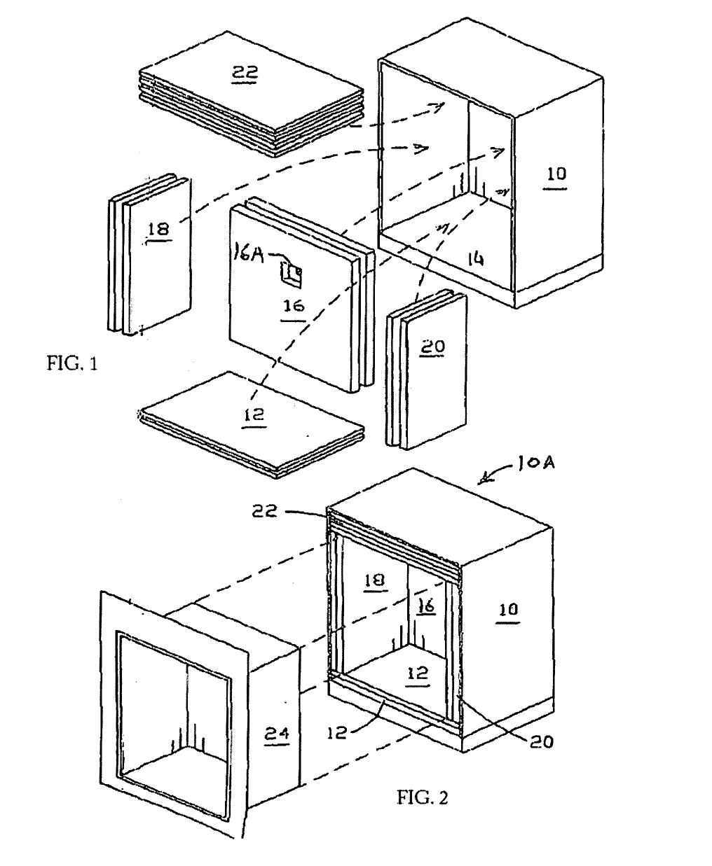

FIG. 1 shows an initial assembly, a metal outer shell or tub 10, typically of 14 gauge stainless steel, made to receive floor insulation 12 placed on a metal bottom base 14, rear wall insulation 16 configured with a port 16A, side wall insulation 18 and 20, and top insulation 22. The insulation material is TRYMER, a compressed hardboard with a composition including small tangent glass spheres to provide high compressive strength along with a cell structure that provides good thermal insulation properties from room temperature to ULT that can be further enhanced by removing the air and operating it in a vacuum. TRYMER insulation material is supplied by Dow Corning Corporation in large blocks with a rated R insulation value of R-5.0 to 5.5. For purposes of the present invention, it is cut into panels two inches thick. Bottom insulation 12, rear wall insulation 16, sidewall insulation 18 and 20 are all made four inches thick, implemented as two panel layers each two inches thick. For improved bottom-to-top temperature uniformity, the top insulation 22 is made thicker, e.g. eight inches, with four panels each two inches thick. The bottom-to-top temperature gradient can be minimized or even over-compensated by the design choice of thickness of the top insulation 22.

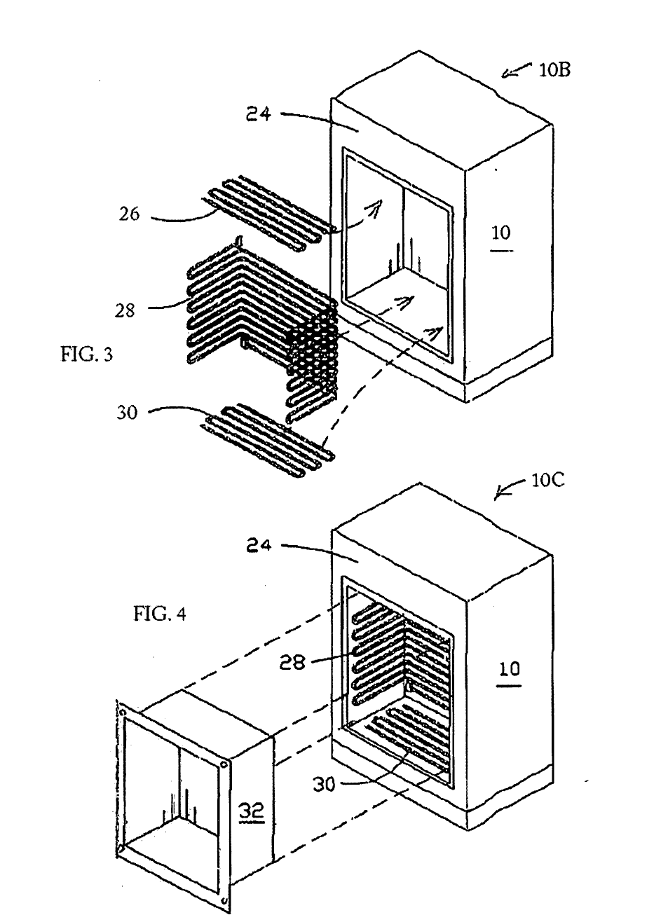

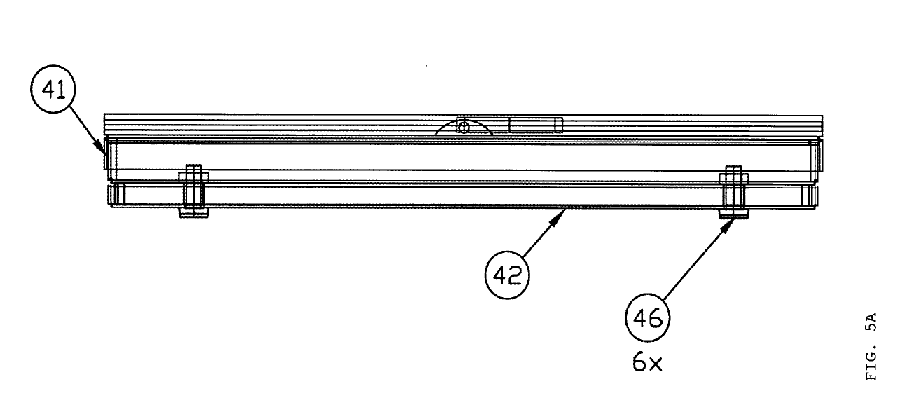

FIG. 2 shows the five-sided outer “tub” 10A assembled with a lining of insulation, into which is inserted metal inner “tub” 24, typically of 16 gauge stainless steel, having a front flange which extends around the perimeter. This is seamlessly laser-welded (TIG welds on vacuum chambers have been shown not to work, hence we use standard industry techniques of hand welding. to the alter tub 10 all around in a no leak manner to form an insulation tub 10B as shown in FIG. 3 with the five hollow walls totally enclosed and filled with the Trymer glass sphere insulation material. This wall enclosure is first purged of moisture at 120 degrees C. then evacuated at 100 degrees C. to a vacuum of approximately 0.0002 torr (i.e. 0.2 millitorrs, 1 torr= 1/760 atmosphere) and then sealed off as a vacuum-insulation-flat walled enclosure.

The rigidity and high compressive strength of the Trymer insulation material serve to counteract and minimize inward bending distortion of the two opposed metal sheets due 10 stress from the internal vacuum and external atmospheric pressure. Dow Trymer insulation material, is a polyisocyanurate foam structured with small glass spheres in contact, provides sufficient compressive strength.

The insulation chamber 10B is fitted with refrigeration tubing, preferably high reliability multi-tube thermal exchange structure as disclosed in U.S. Pat. No. 6,804,976 by inventor John Dain, the content of which is incorporated by reference. As disclosed therein, reliability is greatly enhanced by providing two additional redundant lines in addition to the primary line of copper tubing along with suitable routing valve hardware.

A single three-dimensional U-shaped tubing assembly 28 can be formed to cover the region of the two sides and rear panel: this alone may suffice for some applications, however for ULT biomedical purposes, the required lower temperatures, accuracy and uniformity are attainable with addition of a flat refrigeration tubing assembly to the top and/or the bottom panel, preferably both top tubing assembly 26 and bottom tubing assembly 30 as shown in FIG. 3. Tubing fittings for input and output connection to the external refrigeration source are directed through a special port configured and welded in place in the vacuum/insulation assembly, typically in a back region corresponding to port opening 16A in rear insulation 16 (FIG. 1).

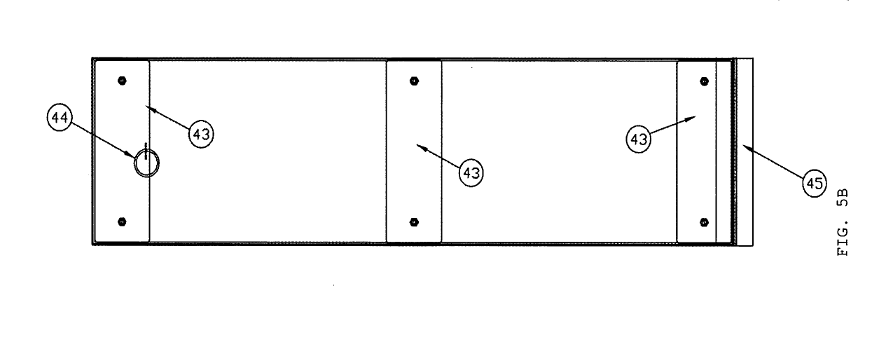

The vacuum insulated tubing assembly 10C, shown In FIG. 4 with the tubing assembles installed in place (e.g. 28 and 30 partially visible), is then fitted with a metal interior liner tub 32 that serves to conceal and. protect the tubing assemblies. Liner tub 32 is configured with a flange extending around its opening which will become the landing for the front chamber door opening, where it may be fastened, e.g. by four screws allowing easy removal for inspection and service of the tubing assemblies. More details on the vessel and insulation chamber are disclosed in co-pending application Ser. No. 11/890,451, filed on Aug. 7, 2007, the content of which is incorporated by reference.

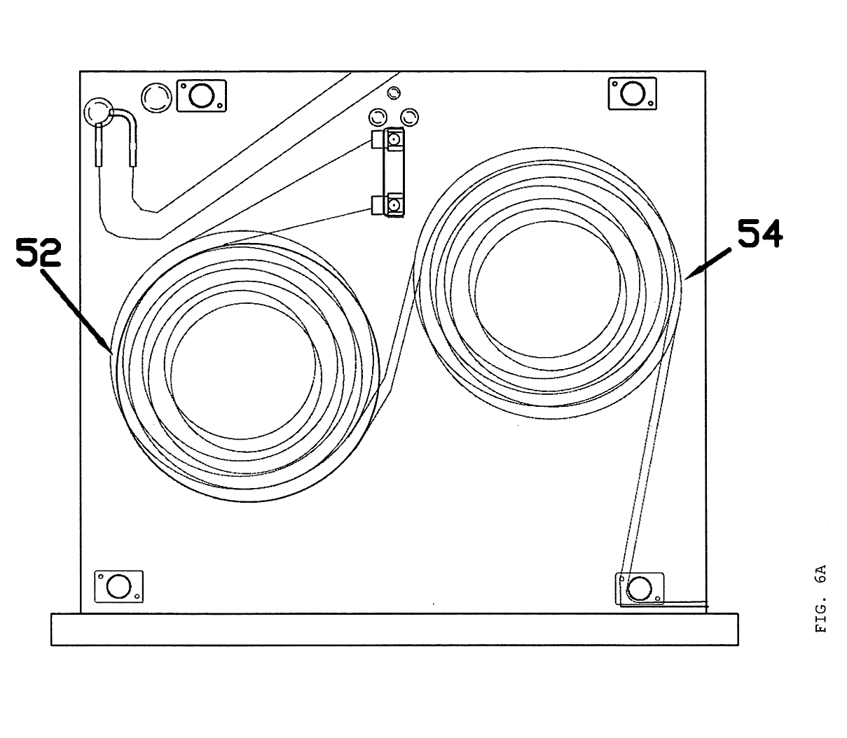

FIG. 5A shows a left view of an exemplary door assembly, while FIG. 5B shows a front view of the door assembly. A rear insulation cover 42 is secured to a front door 41 using a plurality of screws 46. The rear insulation cover 42 provides access to the insulation shell materials in the rear. In one embodiment, the door assembly includes door-sealing gasket and four fastening screws that secure liner tub in place via its flange at the four corners. Typical inside useful payload dimensions of the ULT chamber are 36.5″ wide×47″ high×24¾″ deep.

In FIG. 5A, the door 41 contains a plurality of insulation materials stacked together. Each insulation material has a different thermal characteristic such that when stacked together, the combined insulation materials provide superior insulation. In one embodiment, three separate materials are used: polyisocyanurate, G10 fiberglass (Garolite) and 304 stainless steel. G10-FR4 (FR4) is a fire rated electrical-grade, dielectric fiberglass laminate epoxy resin system combined with a glass fabric substrate. The abbreviation “FR4” means: F (for flame) and R (for retardancies) and the 4 is a 4 epoxy. FR4 grades offer excellent chemical resistance, flame ratings (UL94-VO) and electrical properties under dry and humid conditions. The polyisocyanurate insulation is a closed-cell, high-performance insulation for pipe, vessel, equipment and duct applications. This insulation has an ambient k-factor of 0.19 BTU·in/hr·ft2·° F. at 75° F. mean temperature (0.027 W/m·° C. at 24° C.). These doors provide a thermal break between the interstitial space between the main door and the payload bay. This thermal break provides thermal isolation to the payload bay providing exemplary temperature uniformity. The stainless steel is used to provide FDA approved payload contact material and superior structure while at cryogenic temperatures. The tolerances between each door (door space) while at ambient is ±0.000″. This close fit tolerance is required to minimize the heat gain into the payload bay.

Turning now to FIG. 5B, a split ring 44 is positioned on the front door 41. The front door has a plurality of cold side insulation covers 43 along the length of the front door 41 that allows access to the insulation shell materials on the front or cold side of the door. The door 41 has a piano hinge 45 to allow the door to move for access purposes.

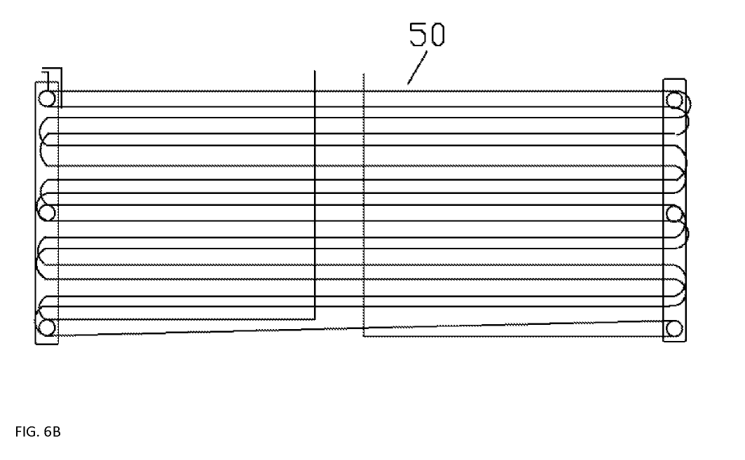

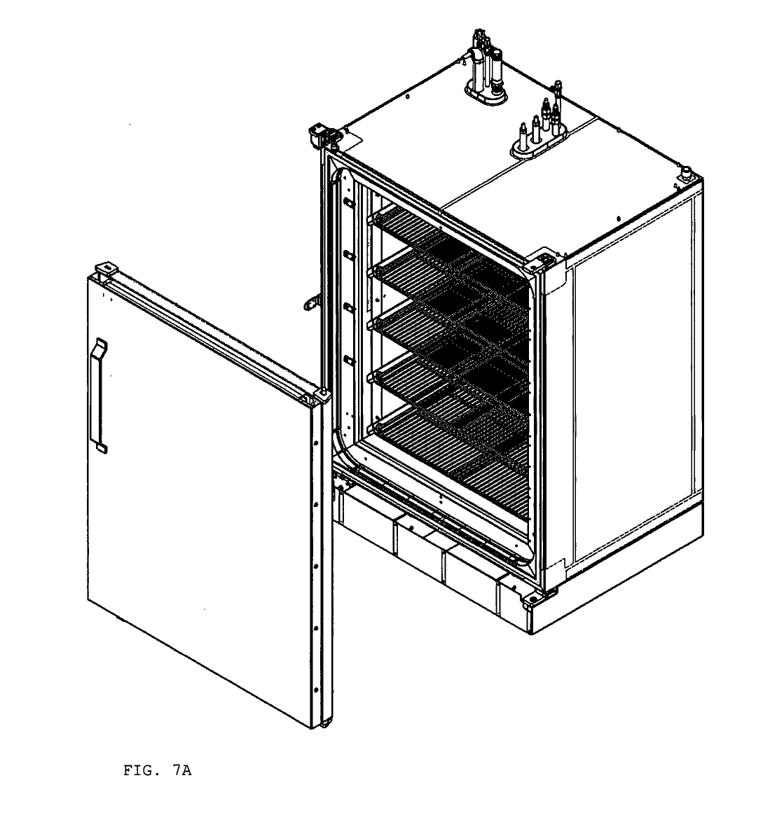

FIG. 6A shows an exemplary cooling coil configuration. In this embodiment, two separate cooling coil circuits are positioned around the payload bay completing the highly reliable cryogenic heat exchanger. As shown in FIGS. 6A-6B, two parallel redundant coil circuits are provided that follow each other in path. Each coil circuit has side tubings 50 and one or more top tubings 52-54. The side tubings 50 can include 125 feet of 0.375″ I.D. copper tube while the top tubing is a concentric coil made from 25 feet of .0.375″ I.D. copper tube. In one embodiment, the top coils 52 or 54 are made from 50 foot spools split in half. The redundant coil circuits are one part of an exemplary highly reliable cryogenic heat exchanger.

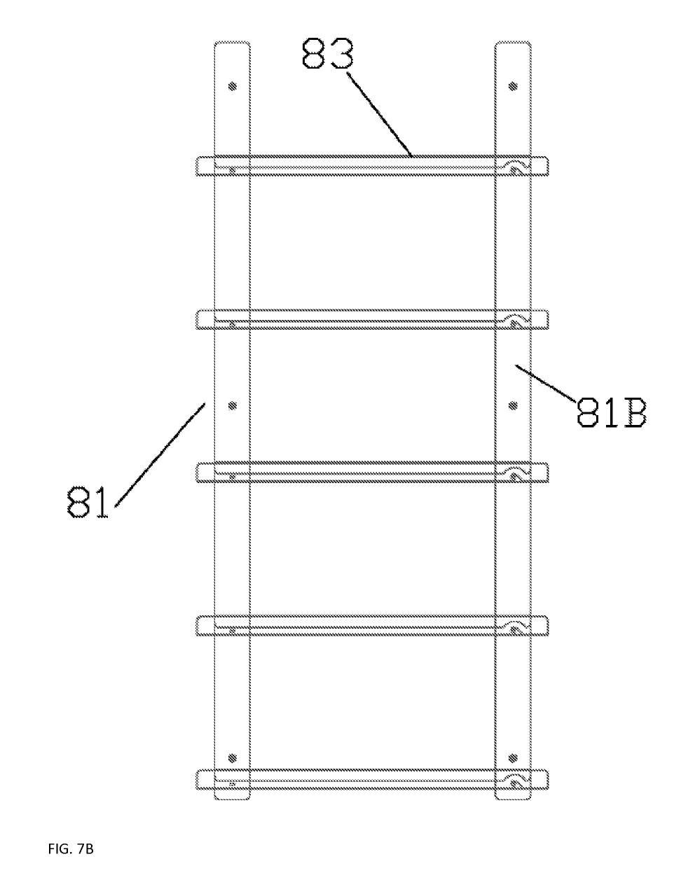

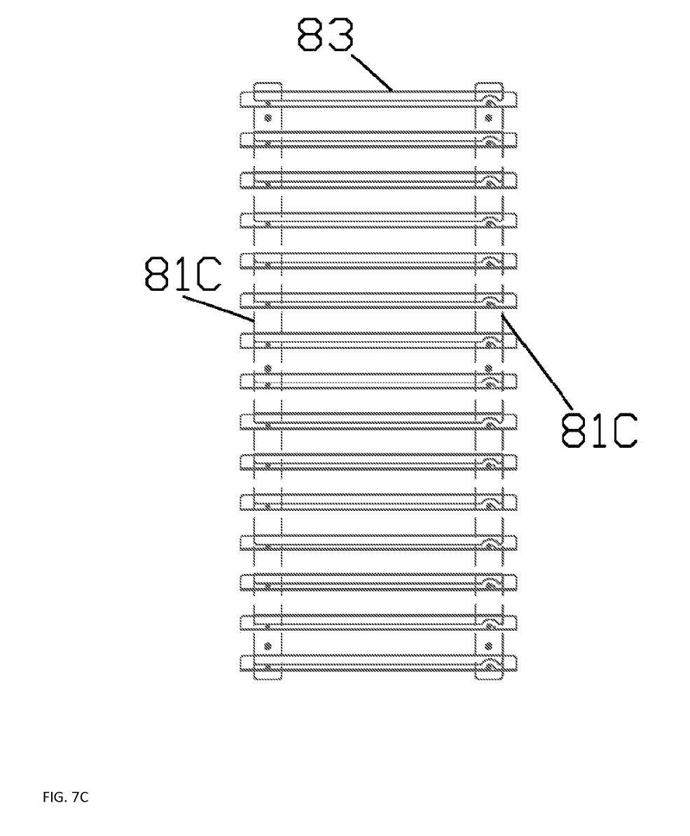

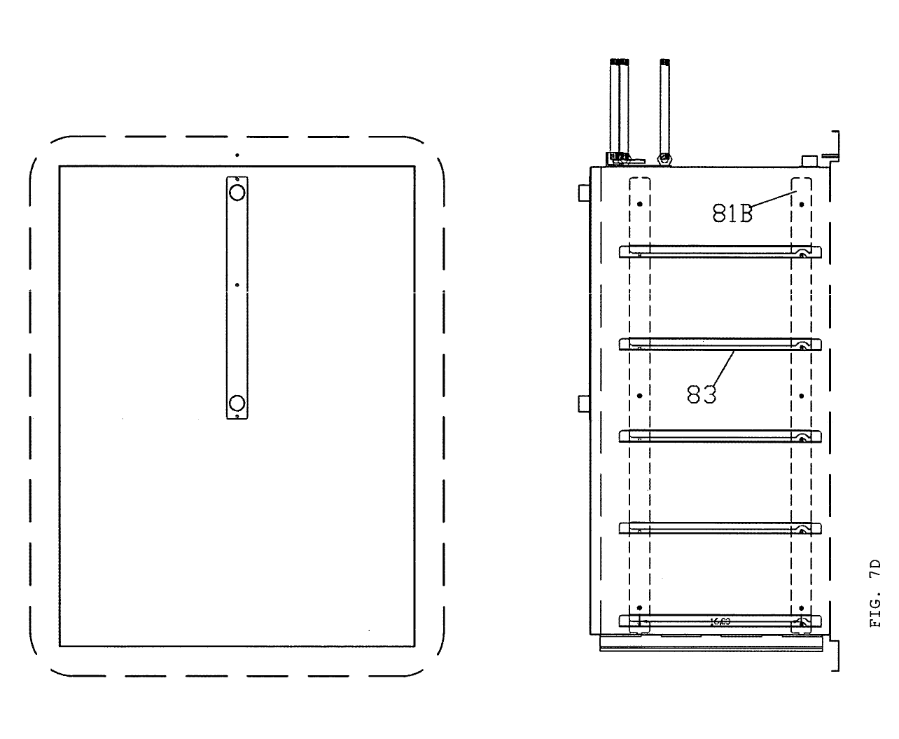

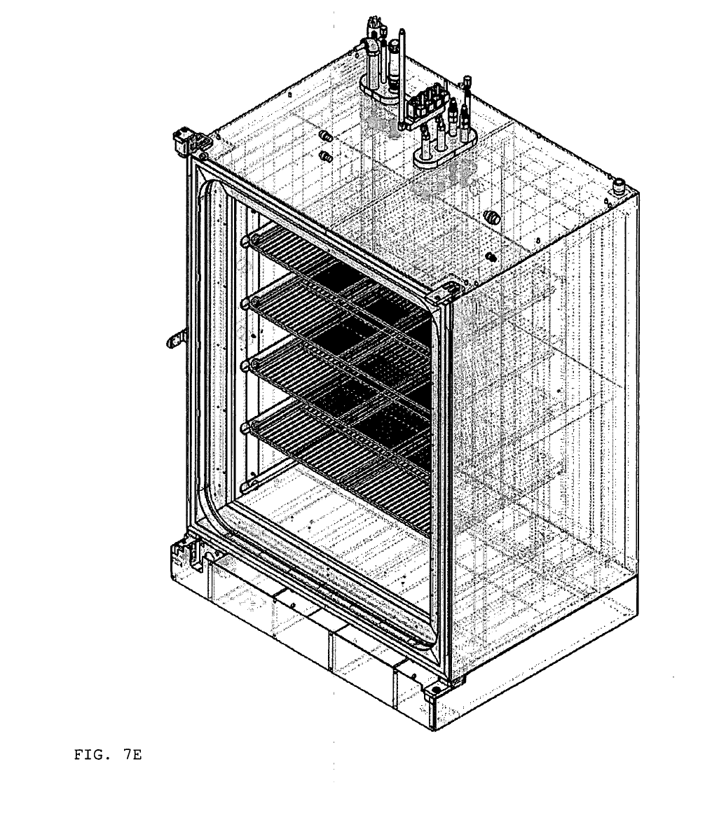

FIGS. 7A-7C shows various alternative embodiments of a rack mount system. Each of the exemplary adaptable and interchangeable rack mount systems in the payload bay has a plurality of shelf racks that can be reconfigured and changed by the user. FIG. 7A shows the door 41 adapted to seal a payload bay with FIG. 7B shows a five rack embodiment, while FIG. 7C shows a fifteen rack embodiment. FIG. 7B has two parallel five slot rack frame support member 81B on left and right sides of the cryogenic processor. Similarly, FIG. 7C has two parallel fifteen slot rack frame support member 81C on left and right sides of the cryogenic processor. Mounted on the support members 81B or 81C are a plurality of shelf racks 83. The shelf racks 83 are secured to the chamber by studs and nuts. Once mounted, one or more drawers can roll on the racks. The user can position the racks to create a five-shelf system, a ten shelf-system, or a fifteen shelf system as desired. Further, the shelf racks provide the primary conduction path for energy removal into the heat exchanger. FIG. 7D shows back and inner side views of the five rack embodiment of FIGS. 7A-7B.

FIG. 7E shows an exploded view of another cryogenic processor embodiment. Operating costs are held low by the combination of the refrigeration process, in this case liquid nitrogen and the insulation efficiency, provided by providing efficient insulation material in an insulating region that is at least four inches thick.

The rectangular shape and proportions of the chamber provides convenient front access though the door, and may be configured internally as a stack of individual compartments (not shown in the drawings), all made independently accessible with minimal effect on other compartments, for efficient inventory control.

Negative environmental effects such air contamination and humidity can be minimized by providing positive pressurization within the ULT chamber(s), preferably with the presence of an inert gas such as nitrogen.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1) An ultra low temperature (ULT) cryogenic processor apparatus, comprising:
a) an external housing with flat sides;
b) an inner housing coupled to the external housing to define a vacuum region there between;
c) material disposed in the vacuum region to provide redundant insulation and structural support; and
d) a cryogenic heat exchanger contained in the inner housing.

2) The apparatus of claim 1, wherein the material comprises an insulation material with one of: a silica micro balloon, polyisocyanurate.

3) The apparatus of claim 1, wherein the vacuum region is processed using a novel method of removing residual water vapor and other partial pressure of contaminants.

4) The apparatus of claim 1, wherein the vacuum region is evacuated to a partial pressure of approximately 0.2 milliTorr.

5) The apparatus of claim 1, wherein the cryogenic heat exchanger comprises one or more tubings.

6) The apparatus of claim 1, where in the cryogenic heat exchanger comprises one or more tubings including redundant tubings.

7) The apparatus of claim 1, wherein the cryogenic heat exchanger comprises U-shaped tubings covering at least three walls of the payload bay.

8) The apparatus of claim 1, wherein the cryogenic heat exchanger comprises tubings covering at least four sides of the payload bay.

9) The apparatus of claim 1, wherein the cryogenic heat exchanger comprises a port coupled to one or more tubings to provide input and output connections thereto.

10) The apparatus of claim 1, comprising a door coupled to the payload bay, wherein the door comprises three or more materials having different thermal characteristics.

11) A method to provide ultra low temperature processing and/or storage, comprising:
a) providing insulation and structural support using a material disposed in a vacuum region between an external housing and an inner housing; and
b) cryogenically processing one or more compartments contained in a payload bay.

12) The method of claim 11, wherein the material comprises an insulation material with silica micro balloon technology.

13) The method of claim 11, comprising removing water vapor, partial pressure contaminates and atmospheric gases from the vacuum region.

14) The method of claim 11, comprising evacuating the vacuum region to approximately 0.2 millitorr.

15) The method of claim 11, wherein the cryogenic heat exchanger comprises one or more heat exchange tubings.

16) The method of claim 11, wherein the cryogenic heat exchanger comprises primary heat exchange tubings including redundant tubings.

17) The method of claim 16, wherein the redundant tubings comprise one of: tubings branched from the primary heat exchange tubings, tubings operating in parallel with the primary heat exchange tubings, U-shaped tubings covering at least three walls of the inner housing.

18) The method of claim 11, comprising providing a door adapted to seal a chamber in the payload bay, wherein the door comprises a plurality of materials each having different thermal characteristics.

19) The method of claim 11, comprising providing a changeable rack assembly in the chamber.

20) The method of claim 19, comprising transmitting energy from the payload bay into the heat exchanger through the changeable rack assembly.

21) The method of claim 11, comprising providing a negative pressure in the payload bay.

22) The method of claim 21, comprising providing pneumatic seals on the main door assembly and cryogenics vacuum pumping through the heat exchanger to remove thermal energy from the payload bay and into the heat exchanger.

23) The method of claim 1, wherein at least one of the external housing and the inner housing comprises a flat surface.
